(19) United States
(12) Patent Application Publication
(10) Pub. No.: US 2010/0201929 A1
(43) Pub. Date: Aug. 12, 2010

(54) DISPLAY DEVICE

(75) Inventors: Naoya Okada, Kokubunji (JP); Mutsuko Hatano, Kokubunji (JP); Shinya Yamaguchi, Mitaka (JP); Takashi Hattori, Musashimurayama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/702,850

(22) Filed: Feb. 9, 2010

(30) Foreign Application Priority Data
Feb. 9, 2009 (JP) 2009-027191

(51) Int. Cl. G02F 1/1333; G02B 27/00

(52) U.S. Cl. 349/122; 359/609

(57) ABSTRACT

Provided is a display device, including: a barrier layer formed of a plurality of material layers being laminated; and a first material layer and a second material layer that sandwich the barrier layer, in which: the first material layer, the plurality of material layers forming the barrier layer, and the second material layer have light refractive indexes that are set so as to sequentially change from the first material layer to the second material layer in one of decreasing order and increasing order; and the plurality of material layers forming the barrier layer include a high stress film and a low stress film which are alternately laminated on each other. Therefore, the display device of the present invention can achieve crack prevention, enhancement in adhesion between the respective layers and enhancement in barrier property, together with reducing a light reflectance of the barrier layer.

### CROSS-REFERENCE TO RELATED APPLICATION

The present application claims priority from Japanese application JP2009-027191 filed on Feb. 9, 2009, the content of which is hereby incorporated by reference into this application.

### BACKGROUND OF THE INVENTION

1. Field of the Invention

The present invention relates to a display device, and more particularly, to a display device including a substrate formed of a flexible plastic substrate.

2. Description of the Related Art

In a display device including a substrate formed of a flexible plastic substrate, the substrate is more light in weight and has higher impact resistance and flexibly compared with a substrate made of, for example, glass.

However, the plastic substrate has higher hygroscopicity and a property of expanding upon absorbing moisture compared with the glass substrate, and hence it is required to form a barrier film for preventing moisture from permeating the plastic substrate, on a surface of the plastic substrate.

In addition, the barrier film is required to be formed with consideration given to stress relaxation and reduction in light reflectance in relation to other materials adjacent to the formed barrier film. Accordingly, the barrier film normally has a laminate structure formed of a plurality of barrier layers.

FIG. 12 illustrates a barrier film BRL having, for example, a three-layer structure in which a low density film LDL is sandwiched between low stress films LFL. In the structure illustrated in FIG. 12, the low stress films LFL are caused to function as stress relaxation layers, to thereby prevent a crack in the barrier film.

FIG. 13 illustrates a barrier film BRL having, for example, a five-layer structure in which a low stress film LFL and a high stress film HFL are alternately laminated on each other. In the structure illustrated in FIG. 13, the adhesion between the respective layers is secured, to thereby enhance a barrier property.

FIG. 14 illustrates a structure in which a barrier film BRL having, for example, a three-layer structure is formed between a plastic substrate SUB (refractive index: 1.5) and a transparent conductive material film TCL (refractive index: 1.9) made of indium tin oxide (ITO), and refractive indexes of respective material layers ML of the barrier film BRL are set to 1.6, 1.7, and 1.8 in the stated order from the plastic substrate SUB side. With this structure, the refractive indexes of the respective material layers ML are changed in a stepwise manner from the plastic substrate SUB to the transparent conductive material film TCL, to thereby reduce a light reflectance. It should be noted that the structure illustrated in FIG. 14 is disclosed in, for example, JP 2000-192246 A and JP 2002-40205 A.

### SUMMARY OF THE INVENTION

In a display device, light for displaying an image inevitably passes through the barrier layer, and hence it is extremely important to reduce the light reflectance of the barrier layer in order to obtain a reliable image. This is because multiple reflection occurs in the barrier layer (having a laminate structure formed of a plurality of layers) that light has entered, and then the barrier layer is colored, which leads to a reduction in image brightness.

However, for the purpose of reducing the light reflectance, when the structure illustrated in FIG. 14 is adopted without any modification, excellent effects may not be obtained in terms of the crack prevention of the barrier layer, the adhesion between the respective layers, and the barrier property. This is because, in the case where the refractive indexes of the respective layers are changed in a stepwise manner, densities and stresses of the respective layers generally become higher along with the increase in refractive indexes thereof, with the result that the structure illustrated in FIG. 12 or FIG. 13 may not be satisfied.

The present invention has an object to provide a display device that includes a barrier layer having a laminate structure formed of a plurality of material layers and is capable of reducing a light reflectance of the barrier layer and also achieving crack prevention, adhesion between the respective layers, and enhancement in barrier property.

The present invention may have, for example, the following structures.

(1) A display device according to the present invention includes: a barrier layer formed of a plurality of material layers being laminated; and a first material layer and a second material layer that sandwich the barrier layer, in which: the first material layer, the plurality of material layers forming the barrier layer, and the second material layer have light refractive indexes that are set so as to sequentially change from the first material layer to the second material layer in one of decreasing order and increasing order; and the plurality of material layers forming the barrier layer include a high stress film and a low stress film which are alternately laminated on each other.

(2) In the display device according to item (1), the first material layer includes a plastic substrate and the second material layer includes a transparent conductive film.

(3) In the display device according to item (1), the first material layer includes a plastic substrate and the second material layer includes a color filter.

(4) In the display device according to item (1), the first material layer includes a plastic substrate and the second material layer includes a silicon-based insulating film

(5) In the display device according to item (1), the first material layer includes a transparent conductive film and the second material layer includes an air layer.

(6) In the display device according to item (1), the first material layer includes a plastic substrate and the second material layer includes an air layer.

(7) In the display device according to item (1), the plurality of material layers forming the barrier layer are made of a silicon nitride-based material.

(8) The display device according to item (1) is a liquid crystal display device.

(9) The display device according to item (1) is an organic electroluminescence (EL) display device.

It should be noted that the above-mentioned structures are given as a mere example, and hence the present invention may be appropriately modified within the scope that does not depart from the technical idea thereof. Further, an example of the structure of the present invention other than the above-mentioned structures is made apparent from an overall description in the specification of the present application or from the accompanying drawings.

The display device having the structures as described above, which includes the barrier layer having the laminate structure formed of the plurality of material layers, is capable of reducing the light reflectance of the barrier layer and also achieving the crack prevention, the adhesion between the respective layers, and the enhancement in barrier property.

Other effects of the present invention are made apparent from the overall description in the specification.

### BRIEF DESCRIPTION OF THE DRAWINGS

In the accompanying drawings:

FIG. 1 is a cross-sectional view illustrating a barrier layer that is formed in a display device according to a first embodiment of the present invention;

FIG. 2 is a cross-sectional view schematically illustrating the display device according to the first embodiment of the present invention;

FIG. 3 is a schematic structural view illustrating a chemical vapor deposition (CVD) apparatus for forming the barrier layer for the display device according to the present invention;

FIG. 4 is a flow chart illustrating a procedure for forming the barrier layer for the display device according to the present invention;

FIG. 5 is a graph illustrating a relation between light refractive indexes and stresses of respective material layers of the barrier layer formed in the display device according to the present invention;

FIG. 6 is a cross-sectional view schematically illustrating a display device according to a second embodiment of the present invention;

FIG. 7 is a cross-sectional view schematically illustrating another display device according to the second embodiment of the present invention;

FIG. 8 is an external appearance view illustrating a portable game machine to which the display device according to the present invention is applied;

FIG. 9 is an external appearance view illustrating a mobile terminal to which the display device according to the present invention is applied;

FIG. 10 is an external appearance view illustrating a rollable TV to which the display device according to the present invention is applied;

FIG. 11 is an external appearance view illustrating an electronic advertising device to which the display device according to the present invention is applied;

FIG. 12 is a cross sectional view illustrating an example of a barrier layer that is formed in a conventional display device;

FIG. 13 is a cross sectional view illustrating another example of a barrier layer that is formed in the conventional display device; and

FIG. 14 is a cross sectional view illustrating still another example of a barrier layer that is formed in the conventional display device.

### DETAILED DESCRIPTION OF THE INVENTION

Embodiments of the present invention are described with reference to the accompanying drawings. It should be noted that identical or similar components are denoted by the same reference symbols in the respective drawings and embodiments, and a description thereof is omitted.

### First Embodiment

### Schematic Structure of Display Device

FIG. 2 is a cross-sectional view schematically illustrating a display device according to the present invention by taking a liquid crystal display device (panel) as an example.

In FIG. 2, a substrate SUB1 and a substrate SUB2 are disposed so as to be opposed to each other with liquid crystal LC being sandwiched therebetween. The substrate SUB1 and the substrate SUB2 are both formed of a plastic substrate made of a flexible resin material.

A barrier layer BRL11 is formed on a liquid-crystal-side surface of the substrate SUB1. The barrier layer BRL11 prevents moisture from permeating the substrate SUB1. A circuit structure layer CRL including a thin film transistor (not shown) is formed on an upper surface of the barrier layer BRL11. The circuit structure layer CRL includes, in each of pixel regions arranged in matrix, a pair of electrodes (pixel electrode and counter electrode) for generating an electric field in the liquid crystal LC. The circuit structure layer CRL has a structure in which an insulating film, a conductive film, and a semiconductor film which are patterned are laminated in a predetermined order. A barrier layer BRL12 is formed on a surface of the substrate SUB1 opposite to the liquid crystal side. The barrier layer BRL12 prevents moisture from permeating the substrate SUB1. A transparent conductive film TCL1 made of, for example, indium tin oxide (ITO) is formed on an upper surface of the barrier layer BRL12. The transparent conductive film TCL1 functions as a shield film for preventing an electric field applied from outside the display device from affecting the liquid crystal LC.

A barrier layer BRL21 is formed on a liquid-crystal-side surface of the substrate SUB2. The barrier layer BRL21 prevents moisture from permeating the substrate SUB2. A color filter CF is formed on an surface of the barrier layer BRL21. In the color filter CF, respective colors of red, green, and blue are assigned to three pixel regions adjacent to one another, and the three pixel regions constitute a unit pixel for color display. It should be noted that a light shielding film referred to as black matrix may be formed at each boundary between the color filters CF having different colors.

A barrier layer BRL22 is formed on a surface of the substrate SUB2 opposite to the liquid crystal side. The barrier layer BRL22 prevents moisture from permeating the substrate SUB2. A transparent conductive film TCL2 made of, for example, indium tin oxide (ITO) is formed on an upper surface of the barrier layer BRL22. The transparent conductive film TCL2 has a function as a shield film for preventing an electric field applied from outside the display device from affecting the liquid crystal LC.

It should be noted that, although not illustrated, an alignment film for determining an initial alignment direction of molecules of the liquid crystal LC is formed on each of a liquid-crystal-side surface of the circuit structure layer CRL and a liquid-crystal-side surface of the color filter CF. Similarly, although not illustrated, a polarizing plate for polarizing light is disposed on each of a transparent-conductive-film-TCL1-side surface of the substrate SUB1 and a transparent-conductive-film-TCL2-side surface of the substrate SUB2.

In the liquid crystal display panel having the above-mentioned structure, a backlight BL is disposed so as to be opposed to, for example, the substrate SUB1, and light L emitted from the backlight BL passes through the substrate SUB1, the liquid crystal LC, and the substrate SUB2 as indicated by the arrow in FIG. 2 to reach an observer (not shown). A transmittance of the light L passing through the liquid crystal LC is changed in accordance with an electric field applied to each pixel region, to thereby enable the observer to recognize an image.

### (Structure of Barrier Layer BRL)

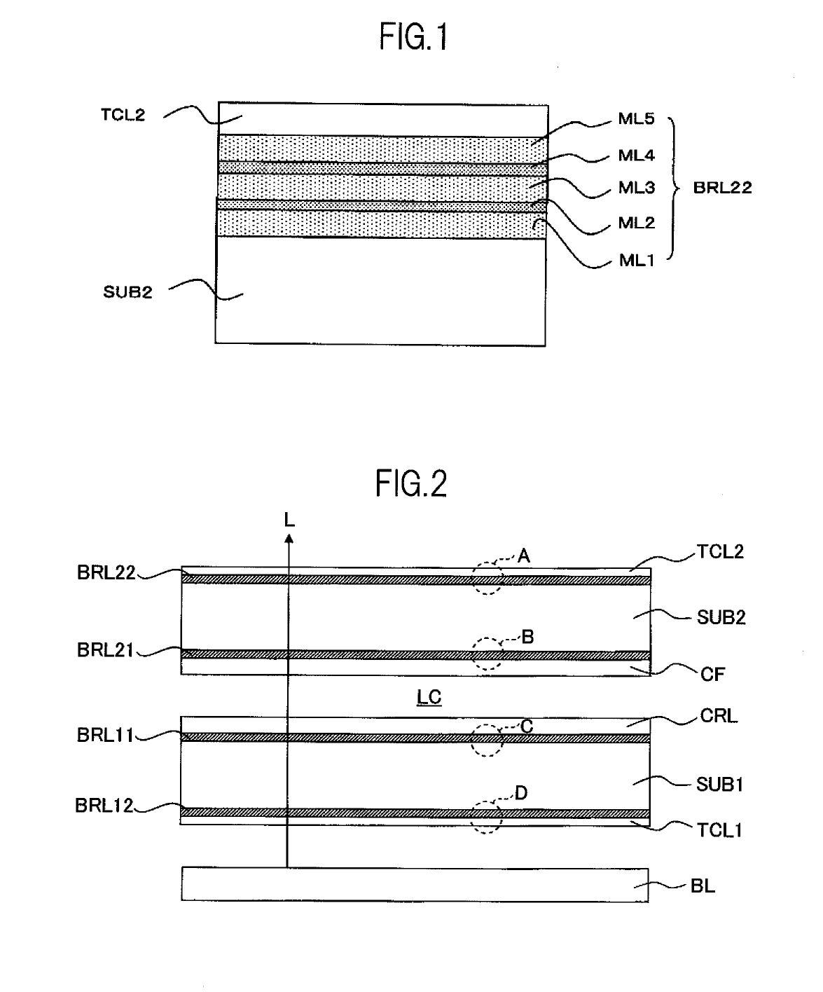

FIG. 1 is a cross-sectional view illustrating a structure of the above-mentioned barrier layer BRL. FIG. 1 illustrates a cross section of a part taken along, for example, the dotted line circle A of FIG. 2. Specifically, FIG. 1 illustrates the barrier layer BRL22 that is sandwiched between the substrate SUB2 made of a resin material and the transparent conductive film TCL2 made of ITO.

The barrier layer BRL22 is formed of a laminate structure in which, for example, a material layer ML1, a material layer ML2, a material layer ML3, a material layer ML4, and a material layer ML5 are laminated in the stated order from the substrate SUB2 side. The material layer ML1, the material layer ML2, the material layer ML3, the material layer ML4, and the material layer ML5 are all made of, for example, a silicon oxynitride-based (SiON-based) material.

In this case, the material layer ML1, the material layer ML3, and the material layer ML5 are formed as a low stress film, while the material layer ML2 and the material layer ML4 are formed as a high stress film. That is, the barrier layer BRL22 formed of the plurality of material layers has a structure in which the low stress film and the high stress film are alternately laminated on each other. With this structure, in the barrier layer BRL22, a crack may be prevented, the adhesion between the respective layers may be achieved, and a barrier property may be enhanced. A method of forming the low stress film and the high stress film as described above is described later.

Further, light refractive indexes of the respective material layers forming the barrier layer BRL22 are set so as to sequentially change in one lamination direction in relation to a light refractive index of each of the substrate SUB2 and the transparent conductive film TCL2 which sandwich the barrier layer BRL22 therebetween. For example, when the light refractive index of the substrate SUB2 is 1.5 and the light refractive index of the transparent conductive film TCL2 is 1.9, the sequential change is made so that the light refractive indexes of the material layer ML1, the material layer ML2, the material layer ML3, the material layer ML4, and the material layer ML5 are 1.6, 1.7, 1.75, 1.8, and 1.85, respectively. As a result, in the laminate structure formed of the substrate SUB2, the material layer ML1, the material layer ML2, the material layer ML3, the material layer ML4, the material layer ML5, and the transparent conductive film TCL2, the light refractive indexes are changed in a stepwise manner from the substrate SUB2 to the transparent conductive film TCL2, to thereby obtain a layer structure having small light reflection.

With the structure as described above, in the barrier layer BRL22 illustrated in FIG. 1, the light reflectance thereof may be reduced, and in addition, the crack prevention, the adhesion between the respective layers, and the enhancement in barrier property may be achieved.

Further, also in a part taken along the dotted line circle B of FIG. 2, the respective material layers ML of the barrier layer BRL21 have a similar relation to that illustrated in FIG. 1. That is, the barrier layer BRL21 is sandwiched between the substrate SUB2 and the color filter CF, and hence the light refractive indexes of the respective material layers ML forming the barrier layer BRL21 are changed in a stepwise manner from the light refractive index of the substrate SUB2 to the light refractive index of the color filter CF. Further, the respective material layers ML of the barrier layer BRL21 are laminated in the state where the low stress film and the high stress film are alternately formed on each other.

Further, also in a part taken along the dotted line circle C of FIG. 2, the respective material layers ML of the barrier layer BRL11 have a similar relation to that illustrated in FIG. 1. That is, the barrier layer BRL11 is sandwiched between the substrate SUB1 and the circuit structure layer CRL. In this case, a layer of the circuit structure layer CRL which is in direct contact with the barrier layer BRL11 is normally formed of an organic insulating film (which may be referred to as silicon-based insulating film in this specification) such as a silicon-nitride (SIN) film. Accordingly, the light refractive indexes of the respective material layers ML forming the barrier layer BRL11 are changed in a stepwise manner from the light refractive index of the substrate SUB1 to the light refractive index of the organic insulating film. Further, the respective material layers ML of the barrier layer BRL11 are laminated in the state where the low stress film and the high stress film are alternately formed on each other.

Still further, also in a part taken along the dotted line circle D of FIG. 2, the respective material layers ML of the barrier layer BRL12 have a similar relation to that illustrated in FIG. 1. In this case, as in the case of FIG. 1, the barrier layer BRL12 is sandwiched between the substrate SUB1 formed of a resin layer and the transparent conductive film TCL1, and thus has a similar structure to that illustrated in FIG. 1.

When forming the barrier layers BRL, the present invention does not need to be applied to all the parts taken along the dotted line circles A to D of FIG. 2, and may be applied to at least one of the parts. Further, FIG. 1 illustrates the barrier layer BRL22 as the laminate structure formed of, for example, five material layers ML. However, the number of the material layers ML is not limited to five, and hence the laminate structure may be formed of a plurality of, that is, other than five, material layers ML.

### (Method of Forming Barrier Layer)

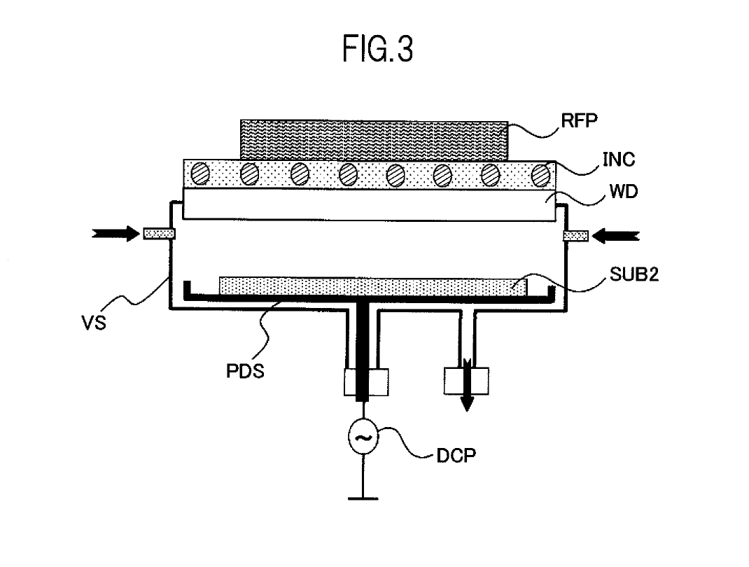

FIG. 3 is a schematic structural view illustrating an apparatus for forming the barrier layer BRL, for example, an inductively coupled plasma chemical vapor deposition (CVD) apparatus.

FIG. 3 illustrates a chamber VS to which a reactive gas is supplied. In the chamber VS, a substrate (for example, substrate SUB2 illustrated in FIG. 1) on which the barrier layer is to be formed may be placed on a substrate pedestal PDS. The chamber VS includes an induction coil INC for generating a plasma inside the chamber VS and a high-frequency transmitting window WD, and the induction coil INC is driven by a radio frequency (RF) power supply (13.56 MHz) RFP. In the above-mentioned apparatus, a large number of excited species are generated by a high-density plasma, which enables film formation at low temperature. When the barrier layer BRL is formed using the above-mentioned apparatus, a bias may be applied, if necessary, to the substrate pedestal PDS by a direct current (DC) power supply DCP.

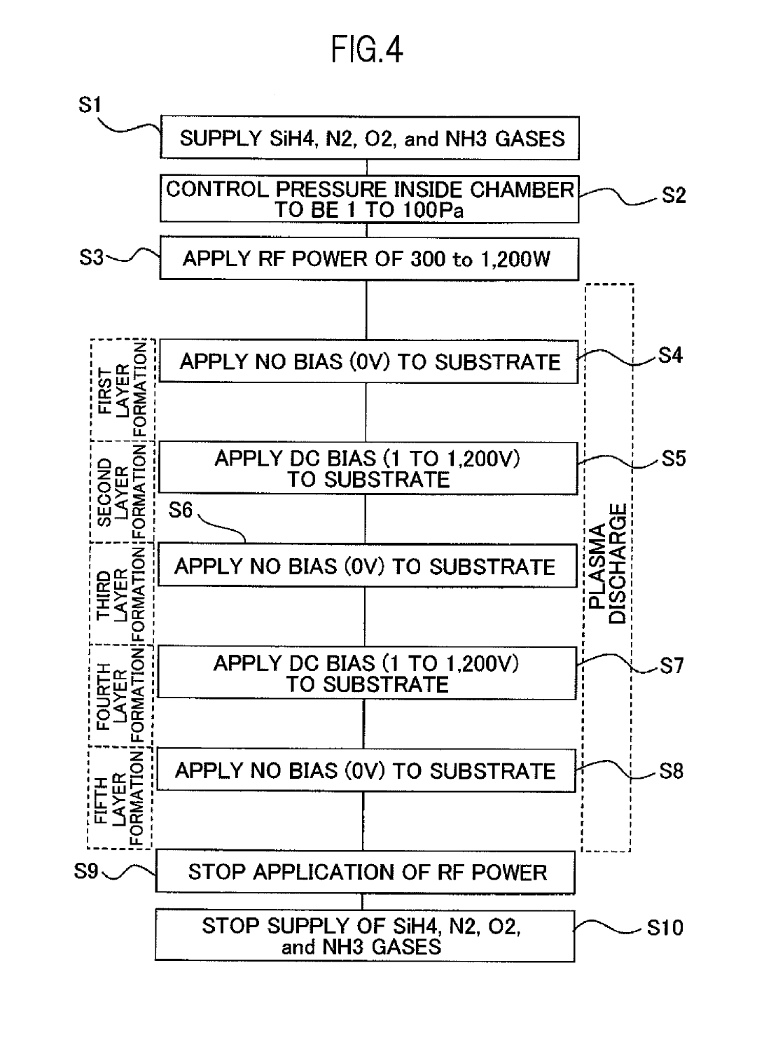

FIG. 4 is a flow chart illustrating a procedure for forming the barrier layer BRL22 on the substrate SUB2 using the apparatus illustrated in FIG. 3.

Referring to FIG. 4, first, as illustrated in Step S1, for example, SiH4, N2, O2, and NH3 are supplied into the chamber VS as the reactive gases, for the purpose of forming the respective material layers of the barrier layer BRL22 of the SiON-based material Next, as illustrated in Step S2, a pressure inside the chamber VS is controlled to be a predetermined pressure value (1 to 100 Pa). Then, in order to fill inside the chamber VS with an appropriate plasma atmosphere, as illustrated in Step S3, an electric power (300 to 1,200 W) is supplied to the RF power supply RFP to start plasma discharge.

After that, the plasma discharge is continued until Step S8, to thereby form the respective material layers ML of the barrier layer BRL22. Specifically, as illustrated in Step S4, in a state where no bias (0 V) is applied to the substrate pedestal PDS, the material layer ML1 (first layer in FIG. 4) is formed. As illustrated in Step S5, in a state where a bias (1 to 1,200 V) is applied to the substrate pedestal PDS, the material layer ML2 (second layer in FIG. 4) is formed. As illustrated in Step S6, in the state where no bias (0 V) is applied to the substrate pedestal PDS, the material layer ML3 (third layer in FIG. 4) is formed. As illustrated in Step S7, in the state where the bias (1 to 1,200 V) is applied to the substrate pedestal PDS, the material layer ML4 (fourth layer in FIG. 4) is formed. As illustrated in Step S8, in the state where no bias (0 V) is applied to the substrate pedestal PDS, the material layer ML5 (fifth layer in FIG. 4) is formed.

Then, as illustrated in Step S9, the electric power supply to the RF power supply RFP is stopped to stop the plasma discharge. After that, as illustrated in Step S10, the supply of SiH4, N2, O2, and NH3 into the chamber VS is stopped.

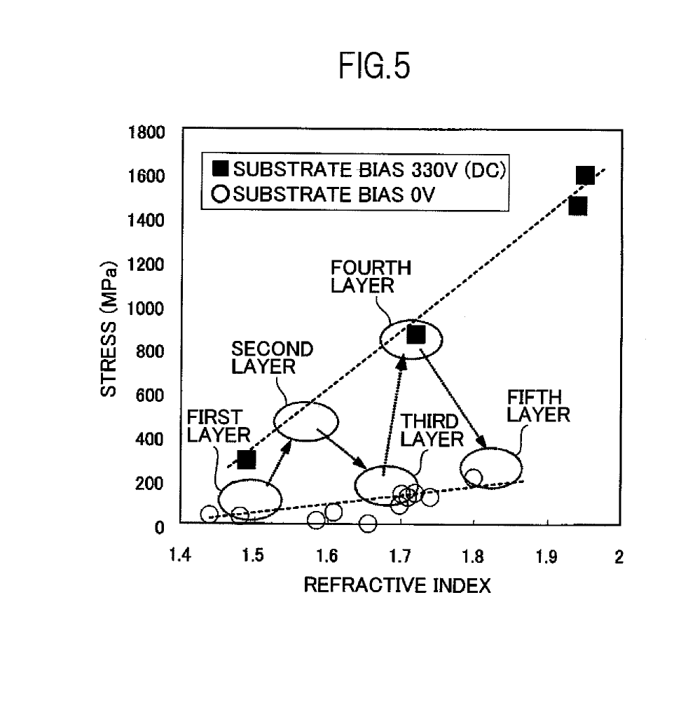

FIG. 5 is a graph illustrating a relation between a light refractive index and a stress (MPa) of each of the material layer ML1 (first layer in FIG. 5), the material layer ML2 (second layer in FIG. 5), the material layer ML3 (third layer in FIG. 5), the material layer ML4 (fourth layer in FIG. 5), and the material layer ML5 (fifth layer in FIG. 5) which are formed as described above. As is apparent from the graph of FIG. 5, the material layer ML1 (first layer in FIG. 5), the material layer ML3 (third layer in FIG. 5), and the material layer ML5 (fifth layer in FIG. 5) each have a relatively small stress, while the material layer ML2 (second layer in FIG. 5) and the material layer ML4 (fourth layer in FIG. 5) each have a relatively large stress. It is understood that the material layer may be formed with no bias being applied in order to make the stress smaller, while the material layer may be formed with a bias being applied in order to make the stress larger. It should be noted that the graph of FIG. 5 illustrates a case of applying a bias of 330 V. In the case of forming the material layer with the bias being applied, a reaction inside the chamber VS of the apparatus illustrated in FIG. 3 is accelerated and thus the material layer may be generated with a high density. Further, it is confirmed that the light refractive indexes of the material layer ML1 (first layer in FIG. 5), the material layer ML2 (second layer in FIG. 5), the material layer ML3 (third layer in FIG. 5), the material layer ML4 (fourth layer in FIG. 5), and the material layer ML5 (fifth layer in FIG. 5) are increased in a stepwise manner in the stated order.

As is apparent from the above description, according to the display device of the present invention, in the barrier layer having the laminate structure formed of the plurality of layers, the light reflectance thereof may be reduced, and in addition, the crack prevention, the adhesion between the respective layers, and the enhancement in barrier property may be achieved.

### Second Embodiment

The first embodiment describes the case that the present invention is applied to a liquid crystal display device. However, the present invention is not limited thereto, and may be applied to other display device such as an organic electroluminescence (EL) display device.

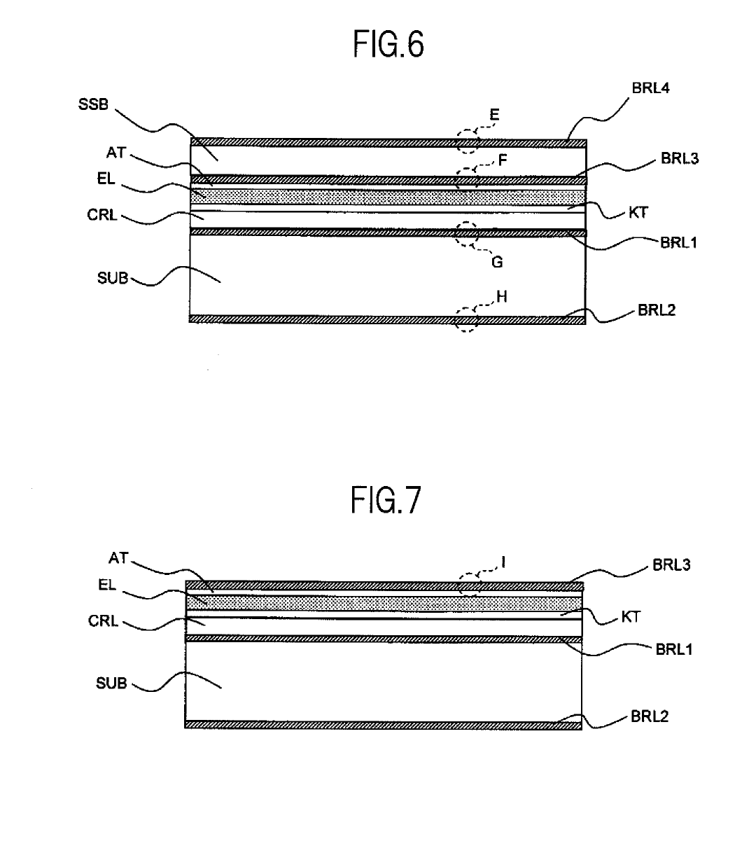

FIG. 6 is a cross-sectional view schematically illustrating an organic EL display device. FIG. 6 illustrates a substrate SUB, which is made of a flexible resin material. A barrier layer BRL1 is formed on one surface (main surface) of the substrate SUB, and a barrier layer BRL2 is formed on another surface thereof. The barrier layer BRL1 and the barrier layer BRL2 prevent moisture from permeating the substrate SUB. A circuit structure layer CRL including a thin film transistor (not shown) is formed on an upper surface of the barrier layer BRL1. A cathode electrode KT is formed in each of pixel regions arranged in matrix on an upper surface of the circuit structure layer CRL. A light emitting layer EL is formed on an upper surface of the cathode electrode KT. An anode electrode AT formed of a transparent conductive film made of, for example, indium tin oxide (ITO) is formed on an upper surface of the light emitting layer EL. The anode electrode AT is formed in common to the respective pixel regions. Further, a sealing substrate SSB formed of a plastic substrate made of a resin material is disposed so as to cover a surface of the anode electrode AT. A barrier layer BRL3 is formed on an anode-electrode-AT-side surface of the sealing substrate SSB, and a barrier layer BRL4 is formed on another surface of the sealing substrate SSB. The barrier layer BRL3 and the barrier layer BRL4 prevent moisture from permeating the sealing substrate SSB.

In FIG. 6, the barrier layer BRL in each of parts taken along the dotted line circles E to H has the laminate structure formed of the plurality of material layers ML as illustrated in FIG. 1. Light refractive indexes and stresses of the plurality of material layers ML have the same relation as that illustrated in FIG. 1. It should be noted that, in the part taken along the dotted line circle E or H, the transparent conductive film (denoted by reference symbol TCL2 in FIG. 1) is not formed on each of a surface of the barrier layer BRL4 opposite to the sealing substrate SSB side and a surface of the barrier layer BRL2 opposite to the substrate SUB side, and the barrier layer BRL4 and the barrier layer BRL2 are thus in contact with the air. In this case, assuming that the barrier layer BRL4 is sandwiched between the sealing substrate SSB and an air layer, light transmittances of the respective material layers ML forming the barrier layer BRL4 in the part taken along the dotted line circle E may be set so as to sequentially change in a stepwise manner from a light refractive index of the sealing substrate SSB to a light refractive index of the air layer.

FIG. 7 is a cross-sectional view illustrating another example of the organic EL display device, correspondingly to FIG. 6. The structure of FIG. 7 is different from that of FIG. 6 in that the sealing substrate SSB and the barrier layer BRL4 formed on the surface of the sealing substrate SSB are removed. In the structure of FIG. 7, the barrier layer BRL3 is provided with a function of the sealing substrate SSB. Therefore, as illustrated in a part taken along the dotted line circle I of FIG. 7, a surface of the barrier layer BRL3 opposite to the transparent conductive film serving as the anode electrode AT of the barrier layer BRL3 is in contact with the air. Also in this case, assuming that the barrier layer BRL3 is sandwiched between the transparent conductive film and the air layer, light transmittances of the respective material layers ML forming the barrier layer BRL3 in the part taken along the dotted line circle I may be set so as to sequentially change in a stepwise manner from a light refractive index of the transparent conductive film to the light refractive index of the air layer.

### Third Embodiment

In the barrier layer BRL of the above-mentioned embodiments, the respective material layers ML which are laminated on each other are made of an insulating material such as SiON. Alternatively, at least one of the material layers ML may be formed of a conductive layer. The conductive layer may be made of, for example, a conductive polymer.

The reason for this is as follows. For example, when the above-mentioned structure is applied to the barrier layer BRL11 formed below the circuit structure layer CRL of FIG. 2 or the barrier layer BRL1 formed below the circuit structure layer CRL of FIG. 6 or 7, an effect of reducing a threshold voltage shift (ΔVth) of the thin film transistor included in the circuit structure layer CRL may be achieved. In this case, the conductive layer may be grounded or may not be grounded. This is because, in both of the cases, the threshold voltage shift (ΔVth) of the thin film transistor may be reduced.

### Fourth Embodiment

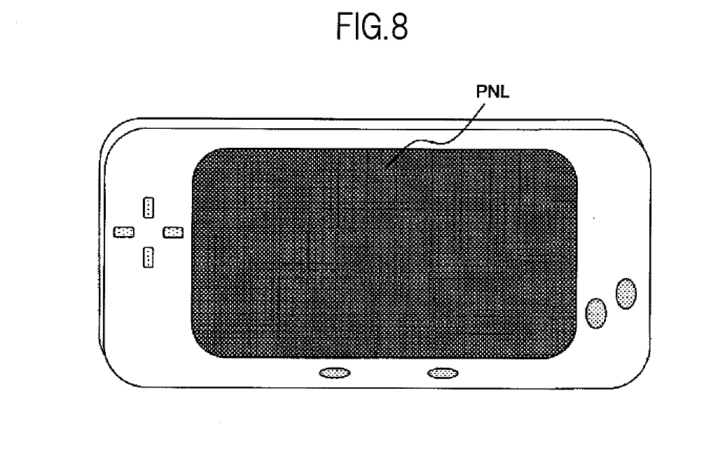

FIG. 8 illustrates a portable game machine to which a display device (panel) PNL according to the present invention is applied. Any one of the liquid crystal display device and the organic EL display device may be used as the display device PNL. Although the display device PNL illustrated in FIG. 8 is not curved, the display device PNL includes a substrate SUB that is made of a resin material or the like, which is light in weight and has high impact resistance.

### Fifth Embodiment

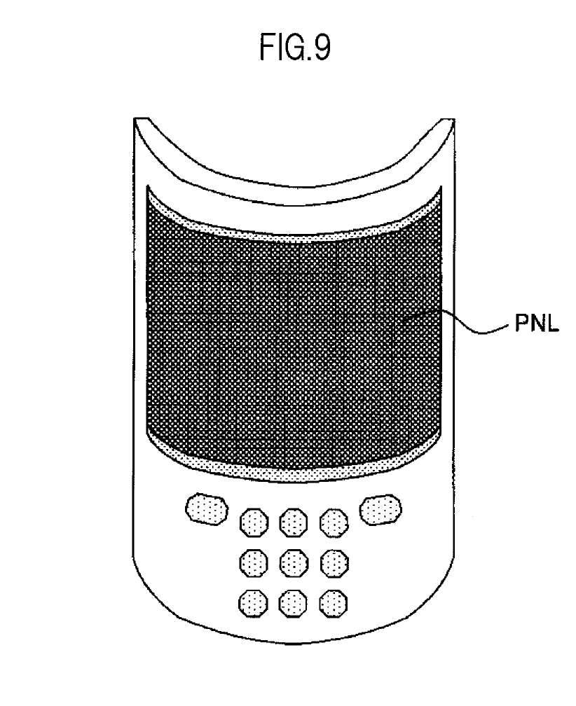

FIG. 9 illustrates a mobile terminal to which the display device (panel) PNL according to the present invention is applied. Any one of the liquid crystal display device and the organic EL display device may be used as the display device PNL. The display device PNL illustrated in FIG. 9 is curved. In this case, barrier layers formed on surfaces of the substrates SUB included in the display device PNL each may be formed so as to generate an overall stress difference, to thereby enable the display device PNL to be easily curved in one direction.

### Sixth Embodiment

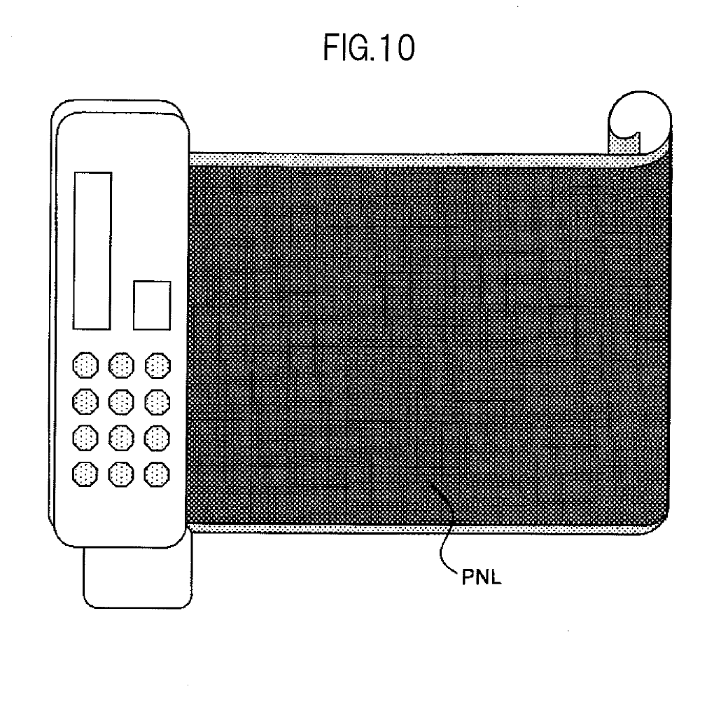

FIG. 10 illustrates a so-called rollable TV to which the display device (panel) PNL according to the present invention is applied. Any one of the liquid crystal display device and the organic EL display device may be used as the display device PNL. Even in this case, barrier layers formed on surfaces of the substrates SUB each may be formed so as to generate an overall stress difference, to thereby enable the display device PNL to be easily rolled up into a main body of the TV.

### Seventh Embodiment

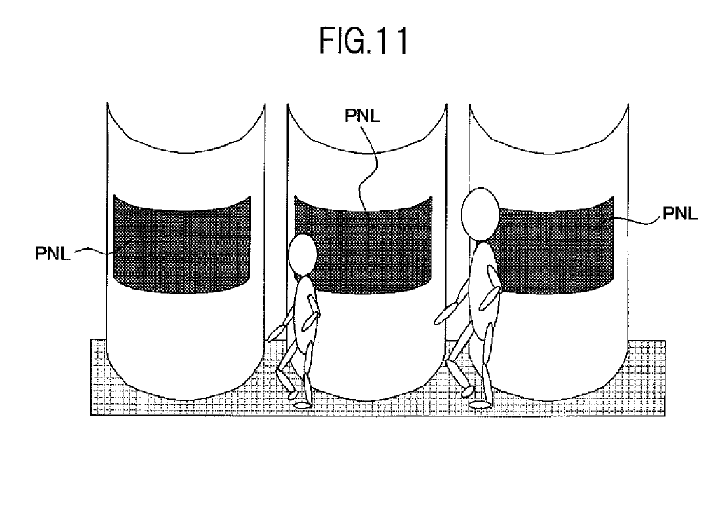

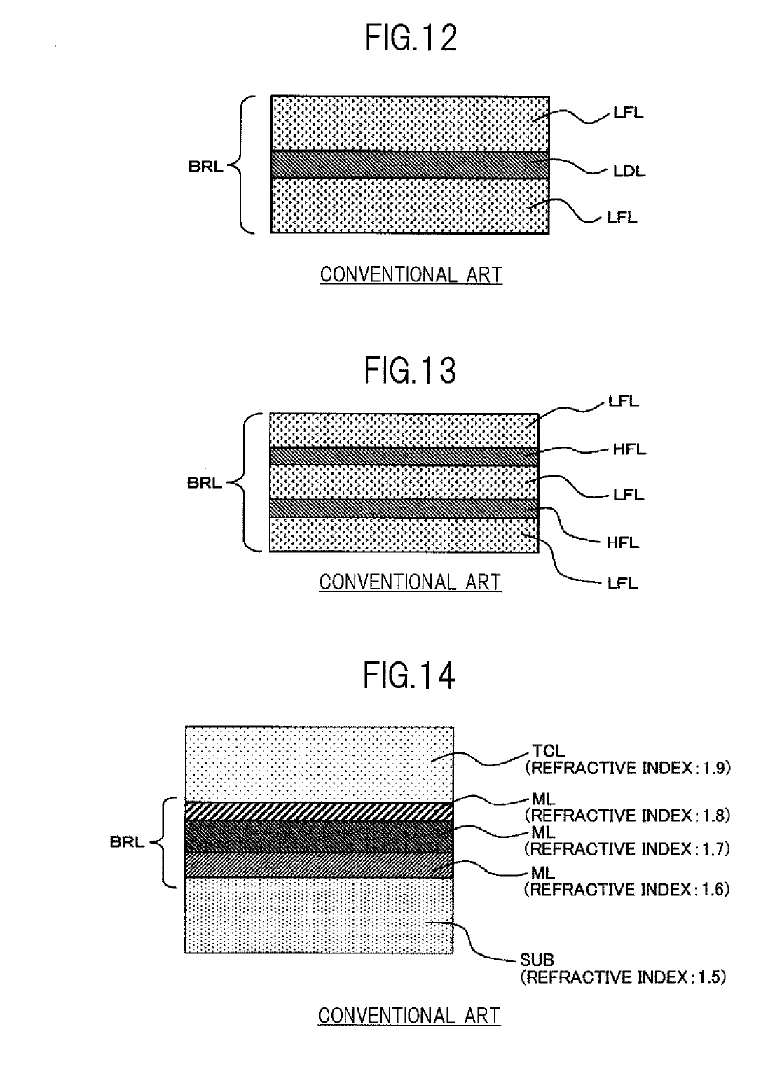

FIG. 11 illustrates an electronic advertisement device to which the display device (panel) PNL according to the present invention is applied. Any one of the liquid crystal display device and the organic EL display device may be used as the display device PNL. The display device PNL illustrated in FIG. 11 is curved. Even in this case, barrier layers formed on surfaces of the substrates SUB included in the display device PNL each may be formed so as to generate an overall stress difference, to thereby enable the display device PNL to be easily curved in one direction.

Hereinabove, the present invention has been described with reference to the embodiments. However, the structures of the embodiments described above are given as mere examples, and hence the present invention may be appropriately modified within the scope that does not depart from the technical idea thereof. Further, the structures of the embodiments described above may be adopted in combination unless the structures are contradictory to each other.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A display device, comprising:
a barrier layer formed of a plurality of material layers being laminated; and
a first material layer and a second material layer that sandwich the barrier layer, wherein:
the first material layer, the plurality of material layers forming the barrier layer, and the second material layer have light refractive indexes that are set so as to sequentially change from the first material layer to the second material layer in one of decreasing order and increasing order; and
the plurality of material layers forming the barrier layer include a high stress film and a low stress film which are alternately laminated on each other.

2. The display device according to claim 1, wherein the first material layer comprises a plastic substrate and the second material layer comprises a transparent conductive film.

3. The display device according to claim 1, wherein the first material layer comprises a plastic substrate and the second material layer comprises a color filter.

4. The display device according to claim 1, wherein the first material layer comprises a plastic substrate and the second material layer comprises a silicon-based insulating film.

5. The display device according to claim 1, wherein the first material layer comprises a transparent conductive film and the second material layer comprises an air layer.

6. The display device according to claim 1, wherein the first material layer comprises a plastic substrate and the second material layer comprises an air layer.

7. The display device according to claim 1, wherein the plurality of material layers forming the barrier layer are made of a silicon nitride-based material.

8. The display device according to claim 1, which is a liquid crystal display device.

9. The display device according to claim 1, which is an organic electroluminescence (EL) display device.
